(19) United States
(12) Patent Application Publication
(10) Pub. No.: US 2009/0323485 A1
(43) Pub. Date: Dec. 31, 2009

(54) RECORDING OPERATION CONTROL DEVICE, INTEGRATED CIRCUIT, OPTICAL DISC RECORDING/REPRODUCING DEVICE, AND RECORDING OPERATION CONTROL METHOD

(76) Inventors: Keisuke Sasaki, Osaka (JP); Noriaki Hamada, Kyoto (JP)

Correspondence Address: MCDERMOTT WILL & EMERY LLP, 600 13TH STREET, NW, WASHINGTON, DC, 20005-3096, US

(21) Appl. No.: 12/374,624

(22) PCT Filed: Jul. 17, 2007
(86) PCT No.: PCT/JP2007/064093

§ 371 Date: Jan. 21, 2009

(30) Foreign Application Priority Data
Jul. 24, 2006 (JP) 2006-200726

(51) Int. Cl. G11B 7/12

(52) U.S. Cl. 369/47.5; G9B/7

(57) ABSTRACT

An information recording precision calculating section (104) calculates an information recording precision for each recording power based on a reproduced RF signal obtained when reproducing recorded information with a predetermined reproduction laser beam intensity after a recording operation of recording the information on an optical disc (200) with a plurality of different recording powers. A relationship information obtaining section (140) obtains relationship information representing a relationship between the recording power and the information recording precision based on the information recording precision calculated by the information recording precision calculating section (104). A relationship information storing section (130) stores relationship information obtained by the relationship information obtaining section (140). A laser control section (150) obtains a recording power corresponding to a target information recording precision based on the relationship information stored in the relationship information storing section (130), and controlling an optical pickup (101) so that information is recorded on the optical disc (200) with the obtained recording power. A relationship information correcting section (180) corrects the relationship information stored in the relationship information storing section (130) based on a state of the optical disc recording/reproducing device (100).

### TECHNICAL FIELD

The present invention relates to, for example, a technique for controlling the laser beam intensity of an optical disc recording/reproducing device for recording and reproducing data to/from an optical disc such as a DVD+R/RW/R DL (Dual Layer), a DVD-R/RW/R DL, a DVD-RAM, or a next-generation optical disc and, more particularly, to a technique for adjusting the laser beam intensity during recording.

### BACKGROUND ART

While there are several recording standards for optical discs, they share a common feature of producing a recording pattern signal according to information to be recorded (a signal having a pulse width according to the recording laser irradiation time for forming a pit of a predetermined length). In order to produce a recording pattern signal suitable for an optical disc, an optical disc recording device irradiates a spinning optical disc with laser while varying the recording power to thereby form/erase pits. If the recording power is not appropriate, it is not possible to accurately form/erase pits, whereby data that should have been recorded will not be read out.

Moreover, optical discs of the same standard may have different recording speeds from each other. A recording pattern signal according to the recording speed may be used. Therefore, different recording pattern signals may be used for optical discs of the same standard. It is necessary to set a recording power according to the recording speed and the recording pattern signal of each optical disc.

Patent Document 1 discloses a process, called “OPC (Optimum Power Control)”, of optimizing the recording power using the degree of modulation as an index. The optical disc device disclosed in this document records test data in a test area of an optical disc using 16 steps of recording power, and calculates the degree of modulation for each recording power based on the reproduced RF signal obtained when reproducing the recorded test data. Each degree of modulation calculated is stored while being associated with the recording power. Then, an optimum recording power corresponding to the target degree of modulation is selected based on the relationship between the stored recording powers and the stored degrees of modulation, after which data is recorded with the selected optimum recording power.

An optical disc device for recording an optical disc of a standard where recorded data can be erased, such as a DVD-RW, uses an erasing power for erasing recorded data. The optimum erasing power Per is calculated based on Per=εO·Pbt by using the coefficient εo (the erasing/recording power ratio), which is stored in advance in a memory provided in the optical disc device, or is recorded on the optical disc as LPP (Land Pre-Pit) information.

Patent Document 1: Japanese Laid-Open Patent Publication No. 2003-303416

### DISCLOSURE OF THE INVENTION

### Problems to be Solved by the Invention

However, during recording on a single optical disc, it may become necessary to re-calculate the optimum recording power, following a change in the state of the device, such as switching of the recording speed or a change in the temperature in the device. Therefore, if the optimum recording power is re-calculated by recording test data using 16 steps of recording power each time there is a change in the state of the device, the area used for OPC measurements, i.e., the area used for recording test data, will be large.

Therefore, when using an optical disc whose test area, which is used for OPC measurements, is limited to the peripheral portion, it is necessary to reduce the area used for obtaining the optimum recording power once.

Moreover, if test data is recorded using 16 steps of recording power for re-calculating the optimum recording power each time there is a change in the state of the device, OPC measurements will take a long time.

In view of the above, it is an object of the present invention to reduce the area of an optical disc used for deriving an optimum recording power, and to shorten the amount of time required for deriving the optimum recording power.

### Means for Solving the Problems

The present invention is directed to a recording operation control for controlling a recording power during a recording operation in an optical disc recording/reproducing device, comprising: calculating an information recording precision for each recording power based on a reproduced RF signal obtained by measuring a reflected light intensity when reproducing recorded information with a predetermined reproduction laser beam intensity after a recording operation of recording the information on an optical disc with a plurality of different recording powers; obtaining relationship information representing a relationship between the recording power and the information recording precision based on the calculated information recording precision; storing the obtained relationship information in a relationship information storing section; obtaining a recording power corresponding to a target information recording precision based on the relationship information stored in the relationship information storing section, and controlling an optical pickup so that information is recorded on the optical disc with the obtained recording power; and correcting the relationship information stored in the relationship information storing section based on a state of the optical disc recording/reproducing device.

Thus, the relationship information stored in the relationship information storing section is corrected based on the state of the optical disc recording/reproducing device. Therefore, when the state of the optical disc recording/reproducing device changes, it is possible to obtain new relationship information without performing again a recording operation with a plurality of different recording powers. Therefore, it is possible to reduce the area of an optical disc used for obtaining the recording power, and it is possible to shorten the amount of time required for obtaining the recording power.

### EFFECTS OF THE INVENTION

According to the present invention, when there is a change in the state of the optical disc recording/reproducing device, it is possible to obtain new relationship information, without performing again a recording operation with a plurality of different recording powers. Therefore, it is possible to reduce the area of an optical disc used for deriving the optimum recording power, and it is possible to shorten the amount of time required for deriving the optimum recording power.

### BRIEF DESCRIPTION OF THE DRAWINGS

FIG. 1 is a block diagram showing a configuration of an optical disc recording/reproducing device 100 according to an embodiment of the present invention.

FIG. 2 illustrates a relationship of degrees of modulation of data in different sectors where data is recorded while varying the recording power for different sectors of an optical disc according to an embodiment of the present invention.

FIG. 3 is a block diagram showing a configuration of a signal control section 110 according to an embodiment of the present invention.

FIG. 4 is a block diagram showing a configuration of a laser control section 150 according to an embodiment of the present invention.

FIG. 5 shows an uncorrected curve of the degree of modulation m represented by an equation obtained in advance and a corrected curve obtained by correcting the uncorrected curve according to an embodiment of the present invention.

FIG. 6 is a flow chart showing an operation of the optical disc recording/reproducing device 100 according to an embodiment of the present invention.

FIG. 7 is a flow chart showing an operation of the optical disc recording/reproducing device 100 according to an embodiment of the present invention.

FIG. 8 is a graph showing an ideally-transitioning degree of modulation m and the differential efficiency γ based on the degree of modulation according to an embodiment of the present invention.

FIG. 9 is a graph showing a degree of modulation m with some variations occurring during the measurement of the degree of modulation m and the differential efficiency γ based on the same according to an embodiment of the present invention.

FIG. 10 is a graph showing a degree of modulation m with some measurement variations, the differential efficiency γ corresponding to the degree of modulation m, an approximate curve of an approximate equation obtained from the degree of modulation m, and the differential efficiency γ corresponding to each point along the approximate curve according to an embodiment of the present invention.

### DESCRIPTION OF REFERENCE NUMERALS

100 Optical disc recording/reproducing device
101 Optical pickup
102 Spindle motor
103 Recording operation control device
104 Modulation degree calculating section (information recording precision calculating section)
110 Signal control section
111 RF adjustment section
112 LPF
113 EQ adjustment section
114 Digitization process section
115 PLL circuit
116 Peak detecting section
117 Bottom detecting section
120 Signal quality calculating section
130 Memory (relationship information storing section)
140 Relationship equation calculating section (relationship information obtaining section)
150 Laser control section
151 Light emission intensity control section
152 Recording pattern producing section
160 Motor control section
170 Discontinuation section
180 Relationship equation correcting section (relationship information correcting section)
190 System controller

### BEST MODE FOR CARRYING OUT THE INVENTION

An embodiment of the present invention will now be described with reference to the drawings.

### Embodiment

### Configuration of Optical Disc Recording/Reproducing Device 100

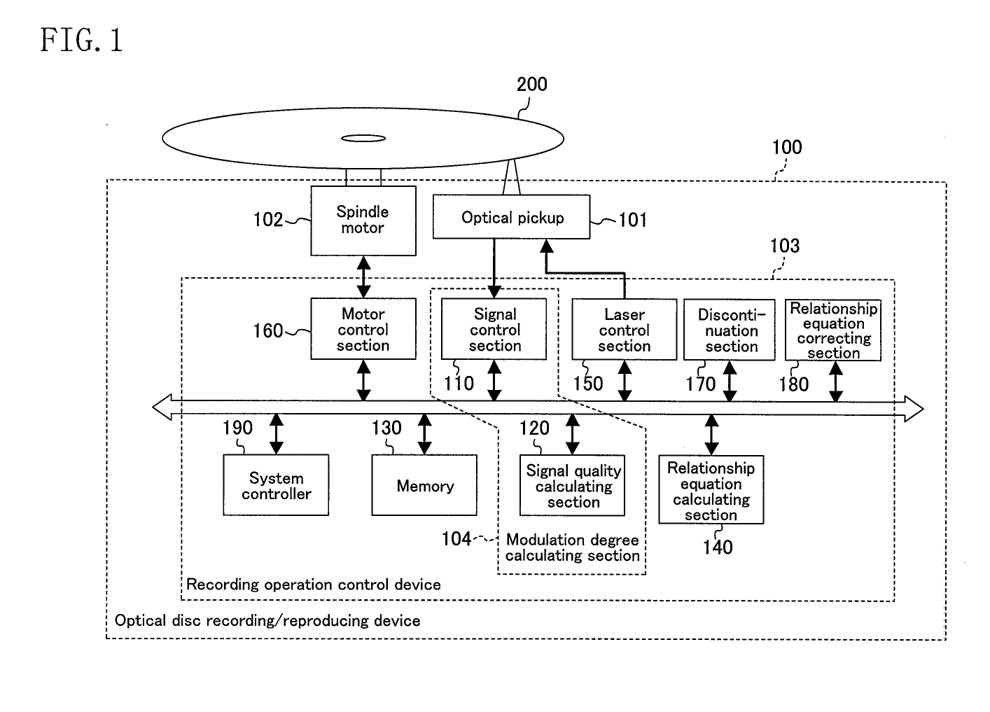

FIG. 1 is a block diagram showing a configuration of an optical disc recording/reproducing device 100 according to an embodiment of the present invention.

The optical disc recording/reproducing device 100 of the present embodiment performs a recording power optimization process called “OPC” before actual data recording. OPC is a process of recording test data while changing the recording power through a plurality of steps and reproducing the test data recorded with different recording power to evaluate the signal quality of each test data, thereby obtaining the optimum recording power. The optical disc recording/reproducing device 100 of the present embodiment records test data while changing the recording power of the laser beam through 16 steps in 16 sectors being the test area provided in a predetermined position of the optical disc. Recording in each sector is performed with one recording power corresponding to the sector. Then, test data recorded in each sector is reproduced and the signal quality thereof is evaluated to thereby obtain the optimum recording power. The recording power herein refers to the output level (intensity) of the laser beam used for recording data on the optical disc. In the present embodiment, the degree of modulation m is used as the value by which the quality of the reproduced signal is evaluated. The degree of modulation m herein refers to a parameter that is calculated by the equation m=(pk−btm)/pk from the peak voltage (pk) and the bottom voltage (btm) of the envelope of the reproduced RF signal (Radio Frequency signal) containing the DC (Direct Current) component, and it is determined that the quality of the reproduced signal is optimum when this value is equal to a predetermined value.

ROPC (Running Optimum Power Control) is a method for performing OPC. ROPC is a method in which the reflected laser light intensity during OPC and that during data recording are compared with each other, and the optimum recording power is corrected as necessary so as to keep the reflected light intensity at a constant level. Similar to ROPC, the optical disc recording/reproducing device 100 of the present embodiment observes the reflected laser light intensity during data recording wherein when the reflected laser light intensity falls off a prescribed value, the recording is discontinued and the recording power is re-calculated. In the present embodiment, the relationship equation is corrected by measuring the signal quality of the portion that is recorded immediately before the discontinuation, and the recording power is calculated based on the corrected relationship equation. With the optical disc recording/reproducing device 100 of the present embodiment, when the OPC information (information indicating the status of operation during OPC such as the temperature of the recording/reproducing device, the temperature of the disc surface, the linear velocity, and the identification numbers of the disc and the recording/reproducing device being used, the derived optimum recording power, etc.) is recorded on an optical disc 200 with the obtained optimum recording power, the reflected laser light intensity is measured to obtain the prescribed value.

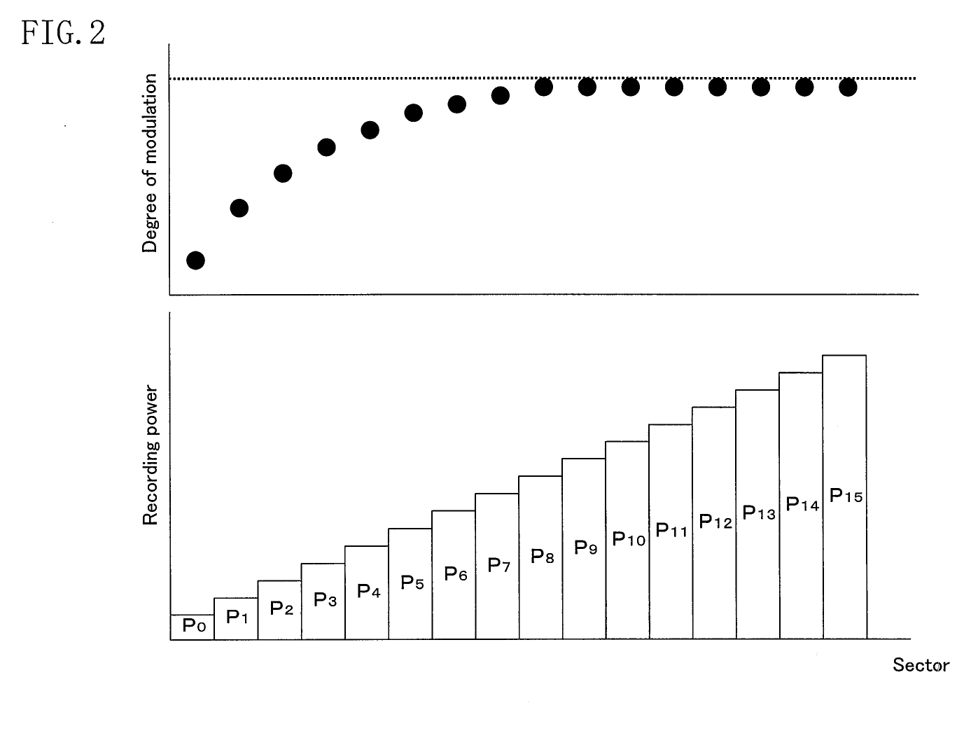

FIG. 2 shows an example of degrees of modulation corresponding to data recorded sector by sector while changing the recording power through 16 steps. In this figure, the recording power transitions from a lower recording power to a higher recording power. Typically, the degree of modulation is measured low on the surface on which data is recorded with a low recording power, and the degree of modulation is measured high on the surface on which data is recorded with a high recording power. However, the degree of modulation will not transition linearly (i.e., the gradient of the degree of modulation will not be constant) with the recording power being increased or decreased linearly. For higher recording powers, the degree of modulation exhibits an asymptotic transition toward a particular value.

The optical disc recording/reproducing device 100 of the present embodiment includes an optical pickup 101, a spindle motor 102, and a recording operation control device 103, as shown in FIG. 1. The recording operation control device 103 is implemented by an integrated circuit called “LSI (Large-Scale Integrated Circuit)”.

The optical pickup 101 irradiates the optical disc 200 spun by the power generated by the spindle motor 102 with a laser beam to thereby record data on the optical disc 200. Moreover, the optical pickup 101 receives reflected laser light and measures the intensity of the received reflected light to thereby obtain a reproduced RF signal. Thus, data on the optical disc 200 is reproduced. Also during recording, the optical pickup 101 receives reflected light of the radiated recording laser beam to obtain, from the received reflected light, a signal representing the amount of reflected light.

The recording operation control device 103 includes a modulation degree calculating section 104 (the information recording precision calculating section), a memory 130 (the relationship information storing section), a relationship equation calculating section 140 (the relationship information obtaining section), the laser control section 150, a motor control section 160, a discontinuation section 170, a relationship equation correcting section 180 (the relationship information correcting section), and a system controller 190. The modulation degree calculating section 104 includes a signal control section 110 and a signal quality calculating section 120.

The signal control section 110 receives the reproduced RF signal obtained from the reflected light received by the optical pickup 101, and converts the reproduced RF signal to reproduced data.

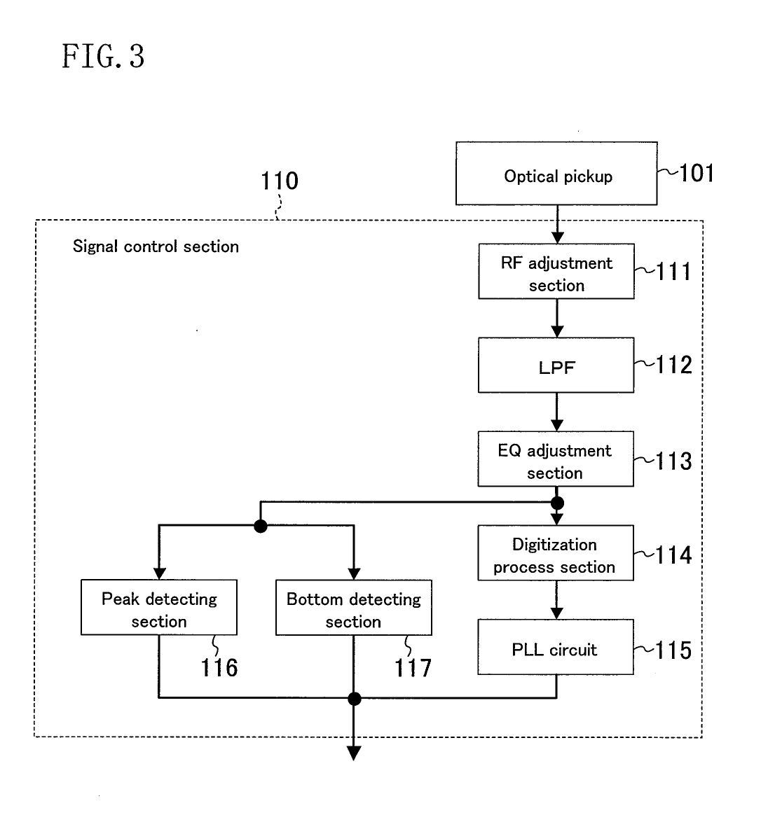

FIG. 3 is a block diagram showing a configuration of the signal control section 110.

The signal control section 110 includes an RF adjustment section 111, an LPF 112 (Low Pass Filter), an EQ adjustment section 113 (Equalizer adjustment section), a digitization process section 114, a PLL circuit 115 (Phase Locked Loop), a peak detecting section 116, and a bottom detecting section 117.

The RF adjustment section 111 adjusts the waveform of the reproduced RF signal obtained from the reflected light of the reproduction laser beam.

The LPF 112 removes noise from the signal whose waveform has been adjusted by the RF adjustment section 111.

The EQ adjustment section 113 shapes the waveform of the signal whose noise has been removed by the LPF 112.

The digitization process section 114 outputs digitized data based on the waveform shaped by the EQ adjustment section 113.

The PLL circuit 115 produces a synchronous clock in synchronism with the digitized data.

A demodulation section (not shown) extracts reproduced data from the digitized data by using the synchronous clock and demodulates the extracted data.

When reproducing the test data recorded with 16 steps of recording power in 16 sectors of the test area during an OPC operation, the signal control section 110 outputs data for measuring the signal quality.

The peak detecting section 116 (peak detector) and the bottom detecting section 117 (bottom detector) obtain data necessary for calculating the signal quality based on the waveform shaped by the EQ adjustment section 113 during the reproduction of the test data. More specifically, data representing the peak voltage (Pk) and data representing the bottom voltage (btm) are obtained based on the waveform shaped by the EQ adjustment section 113. These data are obtained for test data of each sector, and sent to the signal quality calculating section 120.

The signal quality calculating section 120 calculates the degree of modulation m by using the data representing the peak voltage (pk) and the data representing the bottom voltage (btm) obtained by the peak detecting section 116 and the bottom detecting section 117. More specifically, during the reproduction of the test data, the degree of modulation m of test data of each sector is calculated. The degree of modulation m herein refers to a parameter that is calculated by the equation m=(pk−btm)/pk.

The memory 130 (the relationship equation storing section) stores the degree of modulation of test data of each sector calculated by the signal quality calculating section 120 while the degree of modulation is associated with the corresponding recording power. Moreover, the memory 130 stores the parameter of the relationship equation calculated by the relationship equation calculating section 140 to be described later. The memory 130 stores, as the reference amount of reflected light, the amount of reflected light measured by the optical pickup 101 when the OPC information is recorded.

Upon completion of the reproduction of test data of 16 sectors, the relationship equation calculating section 140 calculates the parameter of the relationship equation representing the relationship between the recording power and the degree of modulation, based on the degrees of modulation of test data of 16 sectors stored in the memory 130, i.e., degrees of modulation corresponding to 16 different recording powers. The relationship equation may be, for example, a fourth-order polynomial using approximation. The approximation may be done while excluding measured points with significant variations.

The laser control section 150 controls the laser beam used in recording and reproduction. During actual data recording after the OPC operation, the optical pickup 101 is controlled so that information is recorded on the optical disc 200 with the optimum recording power obtained by substituting the target degree of modulation into the relationship equation represented by the parameter stored in the memory 130.

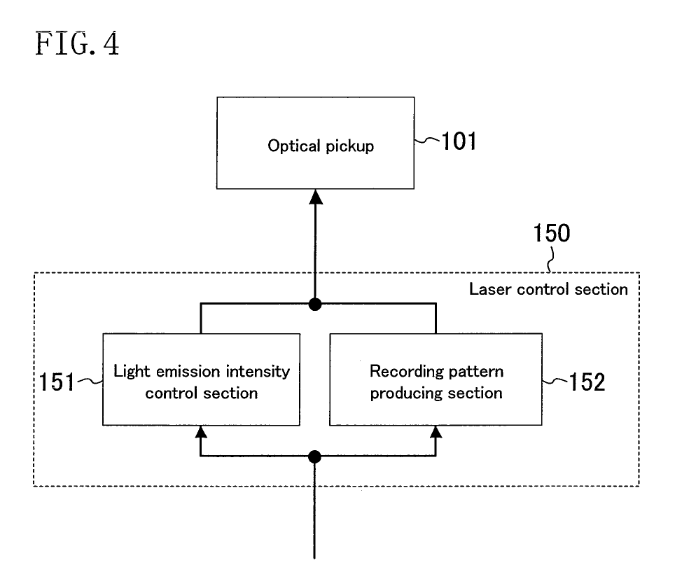

FIG. 4 is a block diagram showing a configuration of the laser control section 150.

The laser control section 150 includes a light emission intensity control section 151 and a recording pattern producing section 152.

The light emission intensity control section 151 controls the laser power (the light emission intensity of the laser beam) used in recording and reproduction. During the reproduction process, the reproduction laser beam is controlled with a predetermined reproduction laser power, which is set during the manufacture of the device. A recording operation is performed during the OPC process for optimizing the recording laser power prior to data recording, and during normal recording operation of recording actual data to be recorded on the optical disc 200. When recording test data, the recording laser beam is changed through predetermined 16 steps of recording power. During the OPC information recording operation and the normal recording operation, the recording laser beam is controlled so that recording is performed with the obtained optimum recording power.

The recording pattern producing section 152 produces a recording pattern signal based on the information to be recorded on the optical disc 200.

The motor control section 160 performs the process of controlling the spindle motor 102.

When there occurs a difference between the amount of reflected light measured by the optical pickup 101 and the reference amount of reflected light stored in the memory 130 during the normal recording operation, the discontinuation section 170 instructs the optical disc recording/reproducing device 100 to discontinue the recording operation. The recording operation is discontinued as the laser control section 150 discontinues the radiation of the recording laser beam from the optical pickup 101, for example.

When recording is discontinued by the discontinuation section 170, the relationship equation correcting section 180 corrects the parameter of the relationship equation stored in the memory 130 based on the degree of modulation of the information recorded immediately before the discontinuation, and the corrected parameter is stored in the memory 130. When the linear velocity of the optical disc 200 changes, the parameter of the relationship equation stored in the memory 130 is corrected according to how the linear velocity changes, and the corrected parameter of the relationship equation is stored in the memory 130.

The correction can be done by, for example, increasing/decreasing the parameter of the relationship equation stored in the memory 130.

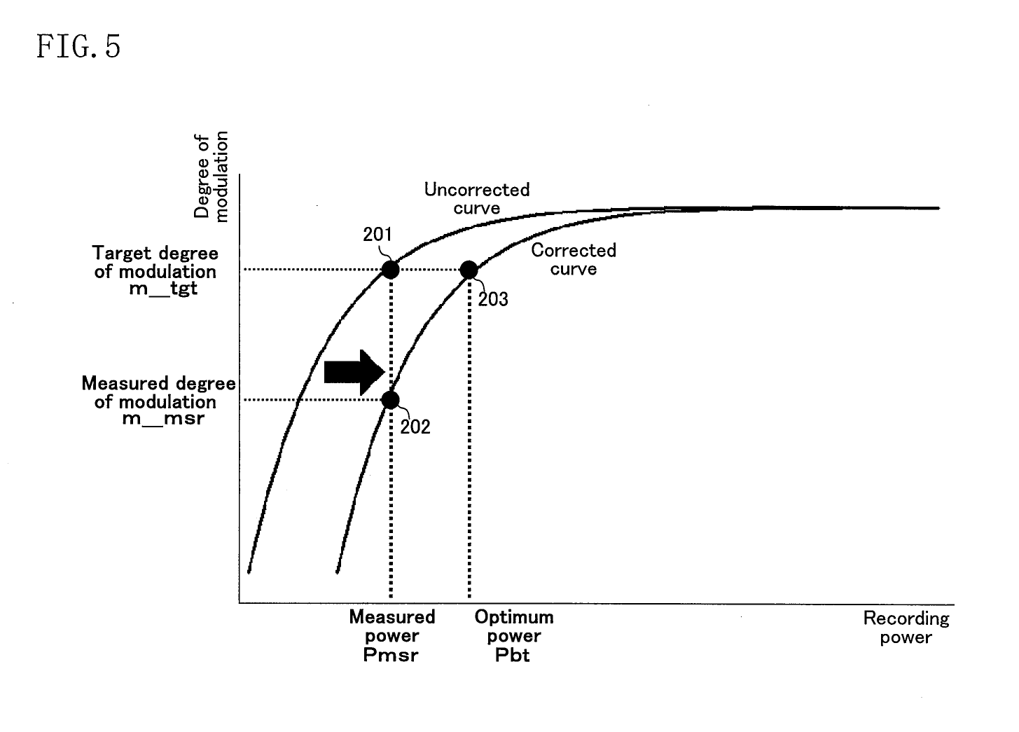

An example of a method of correction by the relationship equation correcting section 180 when recording is discontinued by the discontinuation section 170 will now be described with reference to FIG. 5.

FIG. 5 shows an uncorrected curve of the degree of modulation m represented by an equation obtained in advance and a corrected curve obtained by correcting the uncorrected curve.

Where the relationship equation representing the uncorrected curve (approximate curve) shown in FIG. 5 has already been obtained, and the parameter thereof has been stored in the memory 130, it is possible to obtain a new equation without recording test data again. The following description uses designations shown in FIG. 5. Immediately before the discontinuation of recording by the discontinuation section 170, recording is performed with the recording power calculated by substituting the target degree of modulation m_tgt into the equation representing the uncorrected curve. The recording power is the measured power Pmsr. If the uncorrected curve and the current recording conditions match with each other, the degree of modulation m obtained from the data recorded with the measured power Pmsr is equal to the target degree of modulation m_tgt (i.e., a degree of modulation being the target) as shown by a point 201 in FIG. 5. However, assume that the degree of modulation m obtained from the data recorded immediately before the discontinuation of recording by the discontinuation section 170 is equal to a measured degree of modulation m_msr being different from the target degree of modulation m_tgt as shown by a point 202 in FIG. 5 due to a change in the recording conditions. This means that the recording quality is lowered in proportion to the amount of difference between the target degree of modulation m_tgt and the measured degree of modulation m_msr in a case where recording is performed with the measured power Pmsr. The degree of modulation m obtained from the data recorded immediately before the discontinuation of recording by the discontinuation section 170 is obtained through calculation by the signal quality calculating section 120 after the data recorded immediately before the discontinuation is reproduced by the optical disc recording/reproducing device 100 after the discontinuation.

In the present embodiment, the relationship equation correcting section 180 corrects the equation represented by the parameter stored in the memory 130 to an equation representing the corrected curve. A corrected curve is a curve obtained by shifting an uncorrected curve in the positive or negative direction of the recording power, and is a curve passing through a point whose vertical coordinate is the measured degree of modulation m_msr and whose horizontal coordinate is the measured power Pmsr. In the example of FIG. 5, the corrected curve is a curve obtained by shifting the uncorrected curve in the positive direction of the recording power, and is a curve passing through the point 202 whose vertical coordinate is the measured degree of modulation m_msr and whose horizontal coordinate is the measured power Pmsr. Thus, the equation represented by the parameter stored in the memory 130 is corrected to an equation representing the corrected curve.

Once an equation obtained by correcting the relationship equation represented by the parameter stored in the memory 130 is obtained by obtaining the corrected curve, it is easy to obtain the optimum power Pbt from the target modulation m_tgt.

When the linear velocity of the optical disc 200 changes, a correction is performed by adding or subtracting a predetermined correction coefficient to/from the parameter of the relationship equation stored in the memory 130 according to how the linear velocity changes. The predetermined correction coefficient is set in advance during the manufacture of the device, etc.

The system controller 190 controls the modulation degree calculating section 104, the memory 130, the relationship equation calculating section 140, the laser control section 150, and the motor control section 160.

<Operation of Optical Disc Recording/Reproducing Device 100>

The optical disc recording/reproducing device 100 having such a configuration operates as follows.

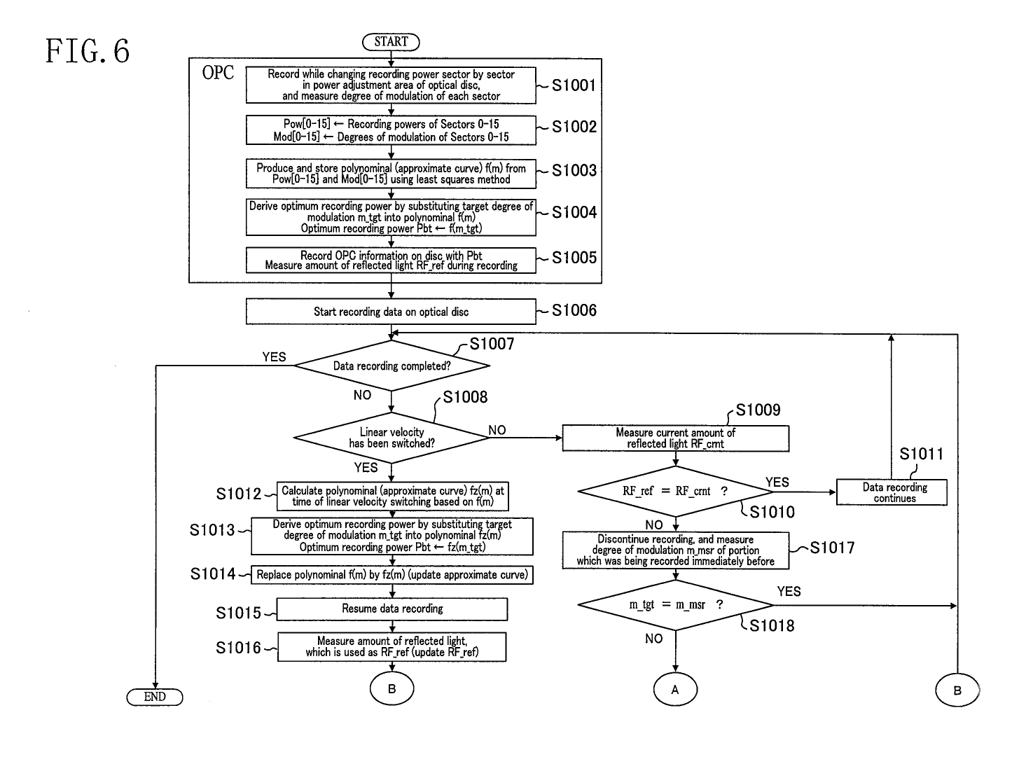

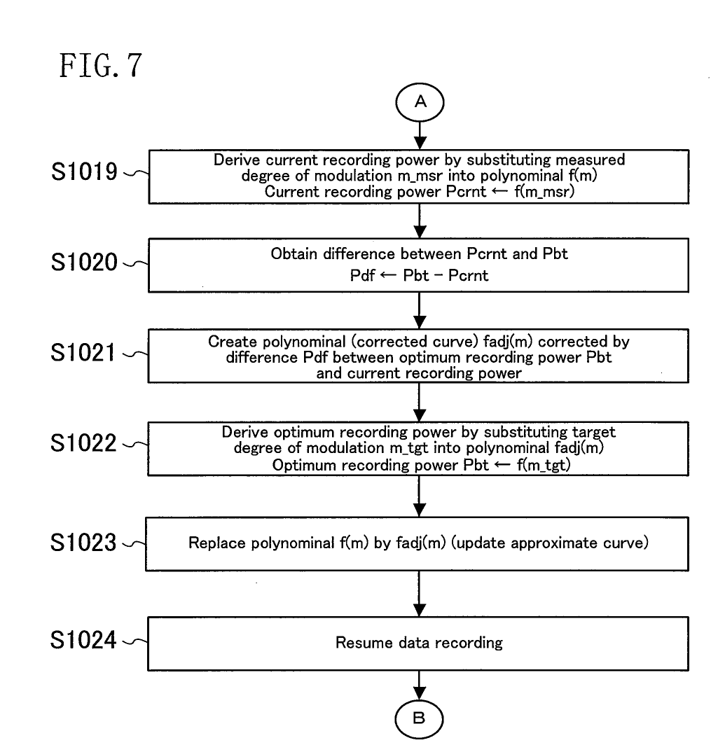

The operation of the optical disc recording/reproducing device 100 of the present embodiment will now be described with reference to FIGS. 6 and 7.

In FIG. 6, (S1001) to (S1005) are OPC processes.

(S1001) Test data are recorded, sector by sector, while changing the recording power in 16 sectors of the test area. The recorded data are reproduced. The modulation degree calculating section 104 calculates the degree of modulation of each recording area (each sector) from the reproduced RF signal measured from the reflected light of the reproduction laser beam.

(S1002) The recording power at the time of recording in each area (each sector) is stored in the memory 130 as Pow[0-15]. The degrees of modulation corresponding to the recording powers are stored in the memory 130 as Mod[0-15].

(S1003) The relationship equation calculating section 140 calculates the parameter of the approximate curve equation f(m) by the least squares method using the recording powers and the degrees of modulation stored in the memory 130 in (S1002). The memory 130 stores the parameter of the approximate curve equation.

(S1004) The optimum recording power Pbt is obtained by using the obtained parameter of the approximate curve equation f(m) and the target degree of modulation m_tgt.

(S1005) The OPC information is recorded on the optical disc 200 by using the optimum recording power obtained in (S1004). In this operation, the optical pickup 101 measures the amount of reflected light RF_ref. The memory 130 stores the measured amount of reflected light RF_ref as a reference for knowing the change in the information recording precision.

(S1006) Recording on optical disc is started.

(S1007) It is determined whether the recording operation is completed, and the process proceeds to (S1008) if not.

The operation in (S1008) and subsequent steps is repeated until the recording operation is completed.

(S1008) It is checked if the linear velocity has been switched to another. If so, the process proceeds to (S1012), and the process proceeds to (S1009) otherwise.

The checking whether the linear velocity has been switched in (S1008) is performed periodically.

(S1009) The optical pickup 101 measures the current amount of reflected light RF_ref.

(S1010) The amount of reflected light RF_crnt measured in (S1009) and the reference amount of reflected light RF_ref measured in (S1005) are compared with each other. If RF_crnt and RF_ref are different from each other, i.e., if the amount of reflected light has changed by an amount greater than or equal to a predetermined amount, it is considered that the recording precision has deteriorated.

(S1011) Data recording continues if the linear velocity has not been switched to another and the amount of reflected light has not changed.

(S1012) If the linear velocity has been switched to another, the relationship equation correcting section 180 calculates the parameter of the equation fz(m) obtained by correcting the equation f(m) by using the parameter of the equation f(m) originally obtained in (S1003).

(S1013) The laser control section 150 obtains the optimum recording power for the linear velocity after the switching by using the parameter of the equation fz(m) calculated in (S1012) and the target degree of modulation.

(S1014) The parameter of the approximate curve equation fz(m) calculated in (S1012) is stored in the memory 130.

(S1015) Recording is resumed with the optimum recording power obtained in (S1013).

(S1016) The optical pickup 101 measures the current amount of reflected light. The memory 130 stores the measured amount of reflected light as the reference RF_ref for knowing the change in the information recording precision. For the linear velocity after the switching, this new amount of reflected light RF_ref is used for the comparison in (S1010). Then, the process returns to (S1007).

(S1017) If the amount of reflected light has changed, the discontinuation section 170 instructs the optical disc recording/reproducing device 100 to discontinue the recording operation. Then, the portion of the optical disc 200 that is recorded immediately before the discontinuation is reproduced. Then, the signal quality calculating section 120 calculates the degree of modulation m_msr based on the reflected light intensity during the reproduction of data recorded immediately before.

(S1018) The degree of modulation m_msr calculated in (S1017) and the target degree of modulation m_tgt are compared with each other. The process proceeds to (S1019) if there is a difference therebetween, and the data recording operation is resumed otherwise.

(S1019) The relationship equation correcting section 180 obtains the recording power Pcrnt that can be assumed from the approximate curve equation f(m) by using the parameter of the approximate curve equation f(m) and the measured degree of modulation m_msr calculated in (S1017). The recording power Pcrnt can be obtained by substituting the measured degree of modulation m_msr into the equation f(m).

(S1020) The relationship equation correcting section 180 obtains the difference Pdf between the recording power Pcrnt obtained in (S1019) and the optimum recording power Pbt currently set.

(S1021) The relationship equation correcting section 180 corrects the approximate curve equation f(m) by using the difference Pdf obtained in (S1020), and obtains the parameter of the equation fadj(m) of the corrected approximate curve (corrected curve).

(S1022) The relationship equation correcting section 180 calculates the optimum recording power using the parameter of the corrected approximate curve fadj(m) and the target degree of modulation. In other words, the new optimum recording power Pbt is obtained by substituting the target degree of modulation into the corrected approximate curve equation fadj(m).

(S1023) The parameter of the corrected curve equation fadj(m) obtained in (S1021) is stored in the memory 130.

(S1024) Data recording is resumed by using the recording power Pbt calculated in (S1022).

The processes of (S1007) to (S1024) are performed periodically until the data recording is completed.

The data recording/reproduction operation by the optical disc recording/reproducing device 100 is performed with the recording operation control device 103 controlling the optical pickup 101 and the spindle motor 102.

Among all the processes described in (S1001) to (S1024), the calculation and decision processes may be performed by any block of the recording operation control device 103.

An entire disc can be recorded with a recording power that is obtained from an originally-produced relationship equation if the recording conditions do not change while recording on a single disc If the recording conditions change, however, the recording power obtained from a single relationship equation may not always be a recording power of a high precision suitable for recording under the different recording conditions. Nevertheless, depending on the recording condition that changes, the newly calculated relationship equation is close to the originally-calculated relationship equation in many cases. In such cases, it is possible to obtain measurement results of an even higher precision even when the recording conditions change, if the originally-produced relationship equation is corrected as in the present embodiment.

<Regarding Evaluation Index>

With the optical disc recording/reproducing device 100 of the present embodiment, the optimum recording power is obtained by obtaining the parameter of the relationship equation between the degree of modulation and the recording power. Alternatively, a different value representing the information recording precision may be used instead of the degree of modulation.

For example, as the evaluation index for obtaining the optimum recording power, a value β representing the asymmetry of the RF signal may be used, instead of the degree of modulation m. The asymmetry β of the RF signal is a parameter that is calculated from β=(pk+btm−2dc)/(pk−btm) based on the peak voltage (Pk), the bottom voltage (btm), and the DC value (dc) of the RF signal. This value being closer to 0 means that the RF signal is more symmetric about the DC value, i.e., the pit pattern corresponding to the RF signal is more symmetric in the vertical direction. Thus, the asymmetry β of the RF signal can be used as the evaluation index of the optimum recording power.

Alternatively, the differential efficiency γ of the degree of modulation may be used as the evaluation index to adjust the optimum recording power. The differential efficiency γ of the degree of modulation is a parameter that is calculated from the equation γ=(dm/dP)/(m/P) based on the increment (dm) of the degree of modulation and the increment (dP) of the recording power (P). The differential efficiency γ of the degree of modulation is used as the index based on which the optimum recording power is determined, as is the degree of modulation, wherein it is determined that the quality of the reproduced signal is appropriate when the differential efficiency γ is within a predetermined range.

The method in which the differential efficiency γ is used as the evaluation index will now be described.

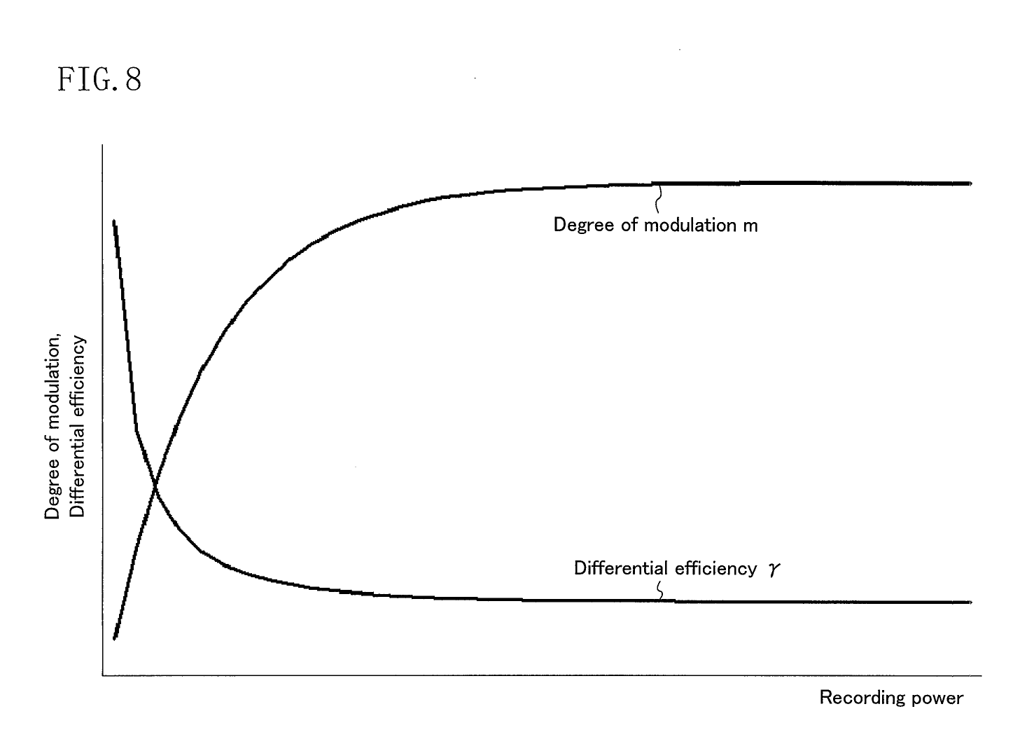

FIG. 8 is a graph showing an ideally-transitioning degree of modulation m and the differential efficiency γ based on the degree of modulation.

Since the degree of modulation m increases in a regular manner, γ being the differential efficiency thereof also transitions in a regular manner. In this case, the differential efficiency γ of the degree of modulation is a parameter that is calculated from γ=(dm/dP)/(m/P) based on the increment (dm) of the degree of modulation and the increment (dP) of the recording power (P). Where the differential efficiency γ is used as an evaluation index, a target γ value is determined in advance, and the intersection between the target γ value and the curve of the differential efficiency γ is searched for, to thereby determine the recording power from the obtained intersection.

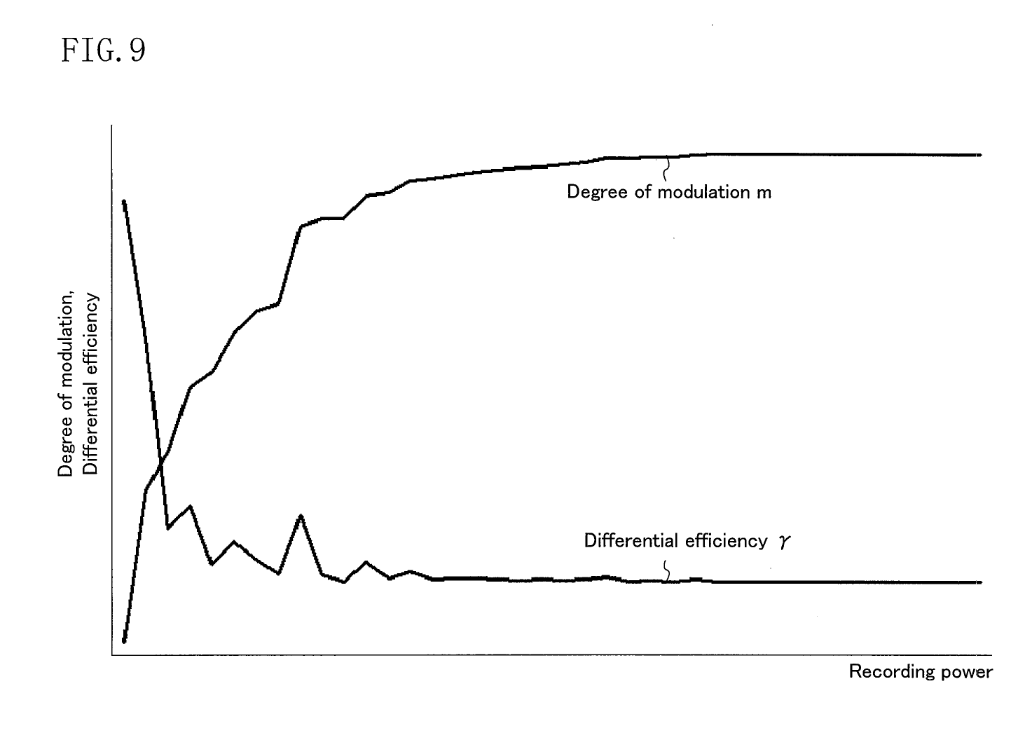

FIG. 9 is a graph showing the degree of modulation m with some variations during the measurement of the degree of modulation m and the differential efficiency γ.

While it is ideal that the degree of modulation m is as shown in FIG. 8, it is not always as smooth as the curve shown in FIG. 8 due to recording conditions, reproduction precision, etc. As shown in FIG. 9, it is possible that the increment of the degree of modulation m is not in a regular relationship with the increment of the recording power. Where the differential efficiency γ is used as the evaluation index, as compared with where the degree of modulation m is used as the evaluation index, it is more likely that the inclusion of even slight variations makes it impossible to obtain a result. This is because if there are repeated ups and downs as with the differential efficiency γ of FIG. 9, it may not be possible to obtain a single intersection with the predetermined target γ value, and the intersection, even if determined, will have a significantly low reliability.

In view of this, there is a method in which a polynomial approximate equation is obtained from the calculated degree of modulation m, and the differential efficiency γ is measured for that approximate equation.

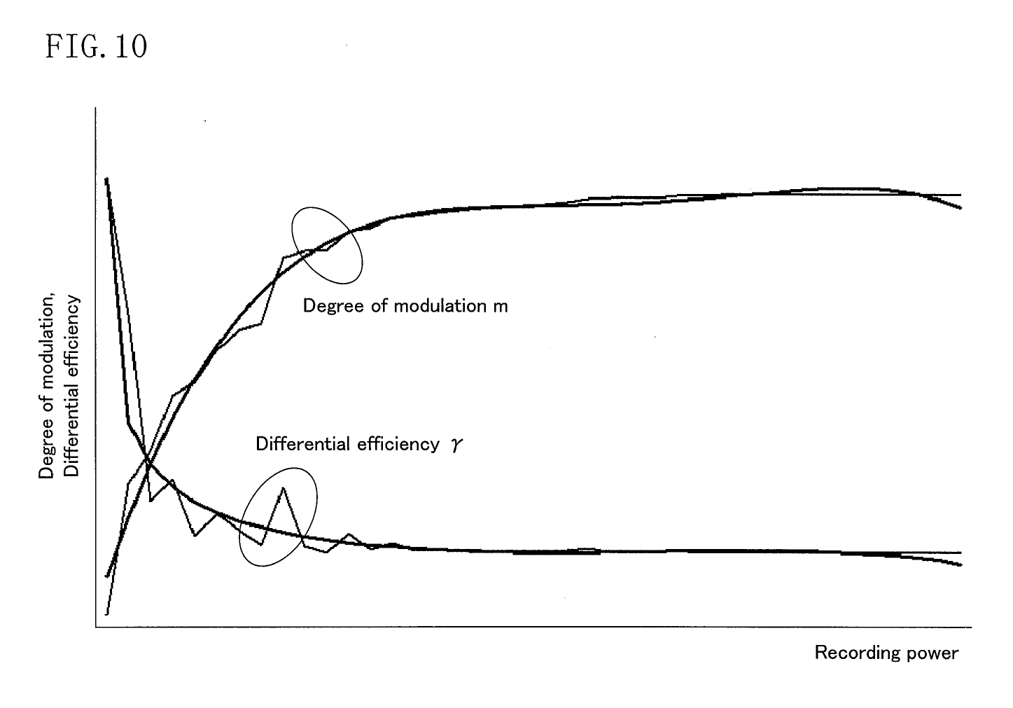

FIG. 10 is a graph showing the degree of modulation m with some measurement variations, the differential efficiency γ corresponding to the degree of modulation m, an approximate curve of an approximate equation obtained from the degree of modulation m, and the differential efficiency γ corresponding to each point along the approximate curve.

As described above, if the differential efficiency γ is obtained directly from the degree of modulation m with variations, it is not possible to obtain a result with which a sufficient reliability of the operation of the device can be maintained. In view of this, an approximate curve of the degree of modulation m is obtained. While there are various methods of approximation, the example illustrated herein is an approximation of the degree of modulation m by using a fourth-order polynomial. The approximate curve of the differential efficiency γ can also be obtained based on the approximate curve represented by the fourth-order polynomial obtained herein.

The differential efficiency γ obtained from the degree of modulation, which is calculated from a measured value and has not been approximated, repeatedly increases/decreases in many places in a series of transitions. Therefore, it is difficult to obtain an appropriate recording power by using the differential efficiency γ as the evaluation index. However, with an approximate curve of the differential efficiency γ obtained based on an approximate curve of the degree of modulation m, it is possible to determine a single recording power for a predetermined target γ value. Therefore, the approximate curve of the differential efficiency γ obtained based on the approximate curve of the degree of modulation m can be used as an evaluation index of a higher precision.

### Alternative Embodiments

(1) In the embodiment above, OPC is performed at the start of recording to obtain the relationship equation. Alternatively, information regarding the originally-obtained relationship equation may be recorded on a lead-in area, for example, on the optical disc, instead of storing the information in the memory 130 of the device, i.e., in the system memory, so that information of the relationship equation recorded on the optical disc 200 is read out if the drive information, or the like, at the start of the second or subsequent recording operation coincides with that when the relationship equation is obtained previously. This makes it possible to adjust the recording power even more efficiently.

(2) In the embodiment above, the relationship equation is obtained by performing OPC at the start of recording. Alternatively, the relationship equation may be stored in the system on the drive so as to shorten the operation necessary for the first OPC.

(3) In the embodiment above, the correction by the relationship equation correcting section 180 is performed when the amount of reflected light measured by the optical pickup 101 becomes different from the reference amount of reflected light, and when the linear velocity of the optical disc 200 changes. Alternatively, the correction may be performed at any other timing. Moreover, the correction may be performed only when the amount of reflected light measured by the optical pickup 101 becomes different from the reference amount of reflected light or when the linear velocity of the optical disc 200 changes. Alternatively, the correction may be performed when there is a change in a state of the optical disc recording/reproducing device 100 other than the amount of reflected light and the linear velocity. For example, the correction may be performed when there is a change in an operation condition, other than the linear velocity, that affects the information recording precision of the optical disc recording/reproducing device 100. When an operation condition is changed, the recording power that is optimal for recording often changes. Therefore, re-calculating the recording power when an operation condition changes can be said to be important for accurate recording of data.

Specifically, the correction may be performed when there is a change in, for example, the angular velocity of the optical disc 200, i.e., the rotation speed, following a change in the recording speed.

Performing the correction when the linear velocity or the angular velocity changes is particularly useful with a recording scheme in which recording is performed at different recording speeds depending on the recording position on the optical disc 200. Such recording schemes include the CLV (Constant Linear Velocity) scheme, the ZCLV (Zoned Constant Linear Velocity) scheme, the CAV (Constant Angular Velocity) scheme, the PCAV (Partial Constant Angular Velocity) scheme, etc. These are schemes in which data is recorded at a lower speed in the inner periphery and at a higher speed as the position moves closer to the outer periphery, and are used for recording with various types of media.

The area that can be used for measurement in OPC is normally the innermost or outermost periphery. With conventional OPC, in an area along the innermost periphery where OPC is performed, OPC is performed at a speed at which recording is performed in the innermost periphery or at a similar speed, thereby obtaining the optimum recording power for the inner periphery. The recording power corresponding to the recording speed for the area where data is recorded subsequent to the inner periphery is obtained by estimating the recording power for the intermediate area and the outer periphery based on the OPC results for the innermost periphery, or by performing OPC in an area along the outermost periphery where OPC can be performed at a speed at which recording is performed in the outermost periphery or at a similar speed to measure the optimum recording power in the outer periphery and then estimating the recording power in the intermediate area based on the OPC results for the inner periphery and the OPC results for the outer periphery.

Thus, where the recording power for the intermediate area is obtained by estimating the recording power obtained from the OPC results for the inner periphery or the OPC results for inner and outer peripheries, it is advantageous that the relationship equation obtained for the inner periphery or for the inner and outer peripheries is corrected according to the recording speed to obtain the recording power from the corrected equation, thereby obtaining the recording power close to the result of performing OPC at the recording speed.

Alternatively, the correction may be performed when there is observed a change in the temperature of the optical disc recording/reproducing device 100 or the surface temperature of the optical disc 200. The measurement of the temperature of the optical disc recording/reproducing device 100 is performed by, for example, a temperature measurement section provided inside the LSI including the recording operation control device 103 for measuring the temperature of the LSI. The measurement of the surface temperature of the optical disc 200 is performed by, for example, a temperature measurement section provided outside the LSI for directly measuring the surface temperature of the optical disc 200. It is possible that the light emission intensity of the laser beam radiated from the optical pickup 101 significantly varies depending on the environment temperature in which the optical disc recording/reproducing device 100 is operating or on the surface temperature of the optical disc 200 itself. For example, where the environment temperature in which the optical disc recording/reproducing device 100 is operating is high, the light emission intensity of the laser beam radiated from the optical pickup 101 is typically low even if the settings for the laser light emission intensity, such as the recording power, are equal to those under the low temperature condition. Therefore, by correcting the relationship equation when the environment temperature or the surface temperature when the recording power is determined vary from those when OPC is performed previously, it is possible to obtain a high-precision recording power that is more suitable for recording.

(4) In the embodiment above, where the linear velocity of the optical disc 200 changes, the correction is performed according to how the linear velocity changes. Alternatively, the correction may be performed based on the degree of modulation, which is obtained from data that is first recorded after the linear velocity changes. Similarly, also where the correction is performed when there is a change in an operation condition other than the linear velocity, the correction may be performed according to how the operation condition changes, or the correction may be performed based on the degree of modulation, which is obtained from data that is first recorded after the operation condition changes.

For example, with recording such as for example a ZCLV scheme recording where the recording area of the optical disc 200 is divided into some zones, and the recording conditions are changed from one zone to another, the degree of modulation m may be obtained for the first recording operation after the recording zone is switched to another, and the relationship equation may be corrected as described above in the example of FIG. 5, wherein the recording power at that time is used as the measured power Pmsr and the degree of modulation for the recording operation is used as the measured degree of modulation m_msr. With the ZCLV recording scheme, the linear velocity is constant for each recording position (zone) on the optical disc 200, and the linear velocity of the optical disc 200 is changed, thus causing a need to set the recording power, when the recording zone is switched to another.

Where the position on the optical disc 200 at which the linear velocity changes during recording or the span on the optical disc 200 over which the linear velocity is kept constant during recording can be specified in advance, as with the CAV (Constant Angular Velocity) recording scheme, the degree of modulation may be measured at the specified position on the optical disc 200 or each time data is recorded over the specified span, and the relationship equation may be corrected based on the relationship between the recording power and the degree of modulation at that time, thus re-adjusting the recording power.

(5) Alternatively, in a case where data is recorded on a single optical disc including a plurality of recording zones of different recording conditions at a plurality of different recording powers, which are obtained by substituting the target degree of modulation into each of a plurality of different relationship equations, and where the parameter of the relationship equation corresponding to each recording zone is recorded in the memory 130, when the parameter for one of the relationship equations is corrected, the parameters for the other relationship equations may be corrected similarly. Then, it is possible to realize recording with a high quality precision.

(6) With the optical disc recording/reproducing device 100 of the embodiment above, the optimum recording power is obtained by substituting the target degree of modulation into the relationship equation calculated based on 16 degrees of modulation corresponding to 16 different recording powers. Alternatively, the recording power corresponding to one of the 16 degrees of modulation stored in the memory 130 that is close to the target degree of modulation can be selected as the optimum recording power without obtaining the relationship equation. In such a case, the modulation degree calculating section 104 is serving the function as the relationship information obtaining section. When a state of the optical disc 200, e.g., the linear velocity, changes, the 16 degrees of modulation stored in the memory 130 may be corrected according to how the state of the optical disc 200 changes, after which the 16 corrected degrees of modulation are stored in the memory 130. Specifically, the relationship equation correcting section 180 may be replaced by a correction section for correcting the degrees of modulation by multiplying the decrees of modulation by a predetermined factor or increasing/decreasing the degrees of modulation by a predetermined amount when the linear velocity changes by a predetermined amount, and then storing the 16 corrected degrees of modulation in the memory 130.

Thus, the information used for obtaining the optimum recording power is not limited to the parameter of the relationship equation, but may be any information that represents the relationship between a plurality of recording powers and the corresponding degrees of modulation.

### INDUSTRIAL APPLICABILITY

The recording operation control device, the integrated circuit, the optical disc recording/reproducing device and the recording operation control method of the present invention have an advantage that the area of the optical disc used for driving the optimum recording power can be reduced and the amount of time required for deriving the optimum recording power can be shortened, and are useful, for example, as a technique for controlling the laser beam intensity of an optical disc recording/reproducing device for recording and reproducing data to/from an optical disc such as a DVD+R/RW/R DL (Dual Layer), a DVD-R/RW/R DL, a DVD-RAM or a next-generation optical disc.

1-18. (canceled)

19. A recording operation control device for controlling a recording power during a recording operation in an optical disc recording/reproducing device;
an information recording precision calculating section for calculating an information recording precision for each recording power based on a reproduced RF signal obtained by measuring a reflected light intensity when reproducing recorded information with a predetermined reproduction laser beam intensity after a recording operation of recording the information on an optical disc with a plurality of different recording powers;
a relationship information obtaining section for obtaining relationship information representing a relationship between the recording power and the information recording precision based on the information recording precision calculated by the information recording precision calculating section;
a relationship information storing section for storing the relationship information obtained by the relationship information obtaining section;
a laser control section for obtaining a recording power corresponding to a target information recording precision based on the relationship information stored in the relationship information storing section, and controlling an optical pickup so that information is recorded on the optical disc with the obtained recording power;
a relationship information correcting section for correcting the relationship information stored in the relationship information storing section based on a state of the optical disc recording/reproducing device; and
a discontinuation section for instructing, during the recording operation, the optical disc recording/reproducing device to discontinue the recording operation, wherein:
the information recording precision calculating section further calculates the information recording precision of information recorded immediately before the discontinuation; and
the relationship information correcting section corrects the relationship information stored in the relationship information storing section based on the information recording precision of the information recorded immediately before the discontinuation.

20. The recording operation control device of claim 19, wherein:
the discontinuation section instructs the optical disc recording/reproducing device to discontinue the recording operation when a deterioration of the recording precision is measured during the recording operation;
the relationship information correcting section corrects the relationship information stored in the relationship information storing section based on the information recording precision of information recorded immediately before the discontinuation if a deterioration of the recording precision is measured during the recording operation; and
the relationship information correcting section corrects the relationship information stored in the relationship information storing section when an operation condition that affects the information recording precision of the optical disc recording/reproducing device changes based on how the operation condition of the optical disc recording/reproducing device changes.

21. The recording operation control device of claim 20, wherein the operation condition that affects the information recording precision of the optical disc recording/reproducing device is a temperature of the optical disc recording/reproducing device or a surface temperature of the optical disc.

22. The recording operation control device of claim 20, wherein the operation condition that affects the information recording precision of the optical disc recording/reproducing device is an angular velocity of the optical disc.

23. The recording operation control device of claim 20, wherein the operation condition that affects the information recording precision of the optical disc recording/reproducing device is a linear velocity of the optical disc.

24. The recording operation control device of claim 19, wherein the discontinuation section instructs the optical disc recording/reproducing device to discontinue the recording operation when a deterioration of the recording precision is measured during the recording operation.

25. The recording operation control device of claim 19, wherein the relationship information is the parameter of the relationship equation representing the relationship between the recording power and the information recording precision.

26. The recording operation control device of claim 19, wherein the relationship information is information representing the information recording precision calculated by the information recording precision calculating section being associated with the recording power.

27. An integrated circuit for controlling a recording power during a recording operation in an optical disc recording/reproducing device, comprising:
an information recording precision calculating section for calculating an information recording precision for each recording power based on a reproduced RF signal obtained by measuring a reflected light intensity when reproducing recorded information with a predetermined reproduction laser beam intensity after a recording operation of recording the information on an optical disc with a plurality of different recording powers;
a relationship information obtaining section for obtaining relationship information representing a relationship between the recording power and the information recording precision based on the information recording precision calculated by the information recording precision calculating section;
a relationship information storing section for storing the relationship information obtained by the relationship information obtaining section;
a laser control section for obtaining a recording power corresponding to a target information recording precision based on the relationship information stored in the relationship information storing section, and controlling an optical pickup so that information is recorded on the optical disc with the obtained recording power;
a relationship information correcting section for correcting the relationship information stored in the relationship information storing section based on a state of the optical disc recording/reproducing device; and
a discontinuation section for instructing, during the recording operation, the optical disc recording/reproducing device to discontinue the recording operation, wherein:
the information recording precision calculating section further calculates the information recording precision of information recorded immediately before the discontinuation; and
the relationship information correcting section corrects the relationship information stored in the relationship information storing section based on the information recording precision of the information recorded immediately before the discontinuation.

28. An optical disc recording/reproducing device, comprising the integrated circuit of claim 27.

29. A recording operation control method using a recording operation control device for controlling a recording power during a recording operation in an optical disc recording/reproducing device, the method comprising:
an information recording precision calculating step of calculating an information recording precision for each recording power based on a reproduced RF signal obtained by measuring a reflected light intensity when reproducing recorded information with a predetermined reproduction laser beam intensity after a recording operation of recording the information on an optical disc with a plurality of different recording powers;
a relationship information obtaining step of obtaining relationship information representing a relationship between the recording power and the information recording precision based on the information recording precision calculated in the information recording precision calculating step;
a relationship information storing step of storing the relationship information obtained in the relationship information obtaining step;
a laser control step of obtaining a recording power corresponding to a target information recording precision based on the relationship information stored in the relationship information storing section, and controlling an optical pickup so that information is recorded on the optical disc with the obtained recording power;
a relationship information correcting step of correcting the relationship information stored in the relationship information storing section based on a state of the optical disc recording/reproducing device;
a discontinuation step of instructing, during the recording operation, the optical disc recording/reproducing device to discontinue the recording operation; and
an immediately-before-discontinuation recording precision calculating step of calculating the information recording precision of information recorded immediately before the discontinuation,
wherein the relationship information correcting step corrects the relationship information stored in the relationship information storing section based on the information recording precision calculated in the immediately-before-discontinuation recording precision calculating step.

30. The recording operation control method of claim 29, wherein the relationship information is the parameter of the relationship equation representing the relationship between the recording power and the information recording precision.
